(19) United States
(12) Patent Application Publication
(10) Pub. No.: US 2005/0052071 A1
(43) Pub. Date: Mar. 10, 2005

(54) Disc type wheel

(76) Inventors: Richard C. Woodward JR., Fullerton, CA (US); Gregory E. Kluwe, Seal Beach, CA (US)

Correspondence Address: Richard C. Woodward Jr., 1119 N. Oakdale, Fullerton, CA, 92831, US

(21) Appl. No.: 10/657,566

(22) Filed: Sep. 8, 2003

(51) Int. Cl. B60B 21/00

(52) U.S. Cl. 301/95.101

(57) ABSTRACT

The present invention resides in a wheel formed from a flat sheet with the outer edge of the center portion changing into many beams extending to and forming the outer diameter in a manner to permit the beams to flex with changing loads on the outer diameter. The outer diameter may be covered with a rubber like material. The disc wheel may have dimples for strength and stiffness. Two sheets and other materials may be used.

### REFERENCES CITED

U.S. Pat. No. 5,415,463 May 16, 1995 Olson & Jones—301/64

### BACKGROUND OF THE INVENTION

This invention resides in an improved disc type wheel with springing action as it rotates on a surface. It has three marketable features. First it looks like a wheel that will rotate with or without a tire and has flexibility. Second it is easily formed from strong low cost material. Third it has a function with no tire requiring air and becoming flat. This wheel may have a strip of rubber like material attached to the outer diameter surface. Also, this wheel has a low rotating inertia for starting and stopping, which will save fuel and brakes. This wheel is basic a disc made from a flat sheet having the rim area formed with many support beams which flex when coming in contact with a surface. Other forms and material may be used.

### DISCRIPTION OF THE PRIOR ART

The first wheel was probably a circular wooden object. The wooden disc got spokes and a wear resistant rim. The contourof the rim changed for different usages, like rolling on a rail or supporting a tire. One of the early tires to provide a softer ride was solid ring shape with many holesparallel to the outer diameter.

### SUMMARY OF THE INVENTION

The present invention resides in an improved wheel formed from a flat sheet with many extending beams to flexand form the surface for the outer diameter. The outer surface may be covered with a tire. Two sheets and other materials may be used.

### DESCRIPTION OF DRAWINGS

FIG. 1 is a cross-sectional drawing through one beam of a disc type wheel with beams projecting from alternate sides.

FIG. 2 is a cross-sectional drawing through one beam of a disc type wheel with beams projecting from one side.

FIG. 3 is a cross-sectional drawing through one beam of a disc type wheel with a dimple.

FIG. 4 is a cross-sectional drawing through a disc type wheel made from two disc.

FIG. 5 is a cross-sectional drawing through one curved beam of a disc type wheel.

FIG. 6 is a cross-sectional drawing through one beam of a disc type wheel with a tire on the outer diameter.

### DETAIL DESCRIPTION OF THE INVENTION

This invention resides in a disc type wheel with many beams extending radial from a disc in a non radial maner to an outer diameter to permit springing action to smooth out a rolling motion. Time, cost and quantity enter and determine the method of manufacture. Progressive dies take a long time to make and the cost is high. Also, for the size of wheels nowin use, the press force would be to large. Shear strength of spring steel (tempered) is 200,000 psi.

$$PT = \frac{LC \times T \times S}{2000}$$

PT=Blanking pressure in tons.
LC=
T=Thickness in inches
T=Thickness in inches
S=Shear strength in psi.

A low cost circle shear will cut a circle for thin material. An abrasive saw will cut material at a good rate but is dirty. Torch cutting will cut any thickness of material. The wheels maybe made from flat or rolled stock. The rolled stock will require a straighten roll. Before cutting the outer circle, center holes may be made. Then rotating and indexing is easy. Coming in from the outer diameter “V”s or “Y”s are cut before bending. There are many patterns of bends possible. Projections can be made for off road or ice and other variations for traction, spring and rigidty. The disc wheels have low rotation inertia for starting and stopping and could save gasoline. A low wind resistant light wheel could made for bicycles from 24 TS aluminum. A rubber like material may be attached to the outer diameter in a groove, holes and bonding. The rubber like band material will distribute the load to adjacent beams. The flat surface of the disc may have straight or circular dimples to increase the strength. There are many ways to manufacture disc type wheels. From a bowl and slit the outer portion creating beams. Bend beams with bars having slits in the end and projections to limit the amount of bend. An indexing sheet mounted between a punch and die. First bend the beams of the disc in a manner requiring a second operation to form the outer diameter. Dimpling a flat sheet metal surface is easy accomplished by striking with any projecting dimple shaped tool against the flat metal surface backed by a rubber like sheet. The disc surface may not be flat but curved and may be plastic.

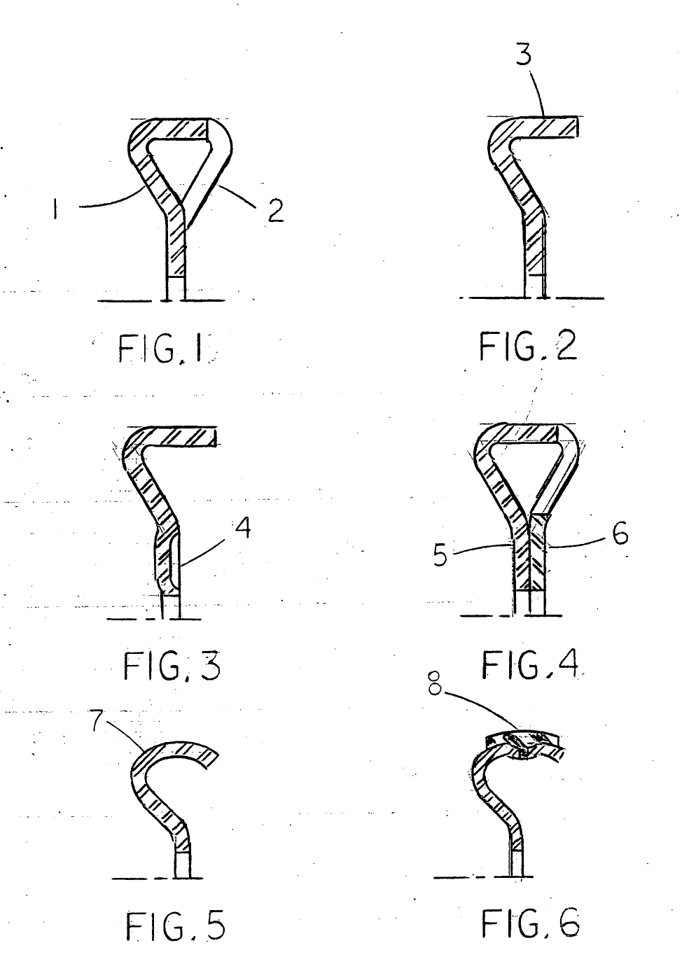

FIG. 1 is a cross-sectional drawing through one beam of a disc type wheel with beams projecting from alternate sides. Cross-section is through beam 1 with beam in view.

FIG. 2 is a cross-sectional drawing through one beam of a disc type wheel with all beams projecting from one side with 3 the outer diameter surface.

FIG. 3 is a cross-sectional drawing through one beam of a disc type wheel with 4 a dimple.

FIG. 4 is a cross-sectional drawing through a disc type wheel made from two discs 5 and 6.

FIG. 5 is a cross-sectional drawing through one curved beamed 7 of a disc type wheel.

FIG. g is a cross-sectional drawing through one beam of a disc type wheel with a tire 8 on the outer diameter.

1. A disc type wheel which comprises a flat portion of a disc with a multidude. two to three hundred, extending non radial beams to an outer diameter permitting a springing action to smooth out rolling on an iregular surface.

2. The disc type wheel described in claim 1, wherein the beams project from alternate sides of the disc.

3. The disc type wheel described in claim 1, wherein the beams project from one side of the disc.

4. The disc type eheel described in claim 1, wherein the surface has dimples.

5. A disc type wheel which comprises two disc type wheels described in claim 3 assembled together to form one wheel with the extended beams of each arranged to accommadate each disc.

6. The disc type wheel described in claim 1, wherein the extended beams can accommodate a rubber like material to form the outer diameter.
